(19) United States
(12) Patent Application Publication
(10) Pub. No.: US 2005/0246248 A1
(43) Pub. Date: Nov. 3, 2005

(54) Mobile portal for radio frequency identification of objects

(76) Inventor: Sarosh Vesuna, Los Altos, CA (US)

Correspondence Address: BAKER & BOTTS, 30 ROCKEFELLER PLAZA, NEW YORK, NY, 10112, US

(21) Appl. No.: 10/837,438

(22) Filed: Apr. 30, 2004

(51) Int. Cl. G06F 17/60

(52) U.S. Cl. 705/28

(57) ABSTRACT

A system utilizes radio frequency identification (RFID) technology to determine the precise location of assets within a large area or building. RFID tags are attached to the assets. A mobile RFID portal, which includes an RFID tag reader, is moved along a select path through the large area or building to read information from RFID tags present in the vicinity of the path. The mobile RFID portal may be moved along the floor or on an overhead rail. The RFID tag information is analyzed along with data on the positions of the mobile RFID portal along the path and/or data on the times-of-read to determine the location of assets associated with the read RFID tags.

### BACKGROUND OF THE INVENTION

The present invention relates to applications of radio frequency identification (RFID) technology that is used for identifying items or assets.

RFID technology exploits electromagnetic or electrostatic coupling in the radio frequency (RF) portion of the electromagnetic spectrum to uniquely identify and locate an item or asset. A conventional RFID system includes three primary components: an antenna and transceiver (often combined into one reader unit), and electronic devices called transponders or tags (the RFID tags) that are attached to the items or assets. The reader unit emits radio waves, and when an RFID tag is within the range of the reader unit, the tag responds and starts sending data.

RFID tags come in a wide variety of size, shapes and forms but have common attributes; each includes low-energy broadcast circuitry, programmable data storage and operating circuitry. Tags come with and without batteries, they can be read only or read/write. Typically, tags without batteries (passive tags) are smaller and lighter than those that are with batteries (active tags), and less expensive.

Reader electronics or units can be bare boards, electronic modules or fully enclosed boxes. The reader units can be fixed or handheld, similar to barcode scanners. Reader units are linked to other software systems that are used to aggregate and integrate the data. The reader unit may be may be linked over a wired or wireless network to a host processor/database for data processing. In some cases the reader units power, engage, download and retransmit data to the tag they encounter.

Low-frequency RFID systems (30 KHz to 500 KHz) have short transmission ranges (generally less than six feet). High-frequency RFID systems (850 MHz to 950 MHz and 2.4 GHz to 2.5 GHz) offer longer transmission ranges (e.g., about 90 feet).

RFID systems are now being proposed for wide spread use in business, e.g., in retail stores, as an alternative to the Universal Product Code (UPC) “bar code” technology. RFID tags are viewed as a superior replacement for UPC bar codes. For example, the data storage capacity in an RFID tag is sufficiently large so that each RFID tag may be assigned a unique code, while UPC codes are limited to a single code for all instances of a particular product. The uniqueness of RFID tags means that each tagged product potentially can be identified individually as it moves from location to location.

RFID systems also are now available for applications such as warehouse management, manufacturing workflow or material management. In these systems, low-cost passive RFID tags are attached to objects such as pallets. RFID tag readers, which generally have a short range generally of about six to ten feet, are deployed to read the RFID tags. RFID tag readers (“portals”) are placed at fixed strategic locations such as dock entrances or doorways to monitor or read RFID-tagged pallets as they pass through. Each RFID reader portal may be wired to an Ethernet network or other standard data communication networks (wired or wireless), so that RFID tag data captured by the RFID reader portal can be transferred through standard interfaces to a host computer, printer or programmable logic controller for storage or action. Such RFID systems can readily provide information on whether a tagged pallet is in or out of a building or on or off the dock, by associating the location of the tagged pallet with the position of the last fixed reader portal it passed through. However, present day RFID systems are not cost effective for locating assets more precisely, for example, in large warehouse or buildings, or for locating high-value assets to within a few feet. The space requirements and the cost of deploying a sufficient number of RFID reader portals in a warehouse to locate precisely where a tagged palette is all times can be prohibitive.

Unlike RFID systems that provide the last known location of an asset based on the position of the last RFID reader portal to scan the asset, alternative wireless systems that can locate assets more precisely have been developed (e.g., Real Time Locating Systems (RTLS)). RTLS consists of readers or antennas to pick up RF signals from active battery-powered RFID tags attached to assets. The readers and antennas are deployed in strategic locations much as conventional access points in wireless data communication network systems are deployed. However, RTLS also has the same cost disadvantages of fixed RFID reader portal systems at least because it involves the use of expensive battery-powered active RFID tags. RTLS systems may be commercially viable for locating high value assets, but less so in high volume, low cost applications such as retail or commodity warehouse or yard management applications.

Consideration is now being given to ways of enhancing RFID systems and methods for more precise determination the location of tagged assets. Attention is in particular directed to arrangements of RFID tag readers for high volume, low cost applications.

### SUMMARY OF THE INVENTION

In accordance with the invention, systems and methods are provided for use in the radio frequency identification of assets within a confined area. The confined area may for example, be a warehouse setting, a closed yard, a manufacturing plant, or other building or space. The systems and methods may be used to locate assets with greater precision than is possible with conventional RFID systems, which use arrangements of fixed or stationary tag readers. The systems and methods may be used to identify assets, which have been tagged, for example, with low cost passive RFID tags

In an embodiment of the invention, a system for locating RFID-tagged assets includes at least one of mobile RFID portal for reading RFID tags. The mobile RFID portal includes an antenna/transceiver reader unit for reading RFID tags using for example, low power RF signals. The reader unit may have a short range. The mobile RFID portal is moved through the area of interest (e.g., a warehouse) along a select path to read RFID tags on assets present in the vicinity of the path. The read RFID tag information is co-related or associated with the position of the mobile RFID portal along the path to precisely locate the assets in the vicinity of the path. Conventional data processing arrangements may be used to analyze the RFID tag information and the data on the mobile RFID portal positions. The read RFID tag information may be time stamped for correlating the locations of the assets with the position of the mobile RFID portal. Time stamping of the RFID tag information also may be advantageously used for time-tracking or analysis of the movement of assets.

The mobile RFID portal may be provided with a wireless radio for transmitting data while in transit. In alternative embodiments, the mobile RFID portal may store RFID tag information data in memory while in transit. The stored data may be later on downloaded at docking station and transmitted for processing over a wired network or any other communication link.

In a warehouse, retail store, manufacturing plant or other buildings, where there is usually other business activity or people on the floor, a grid or network of overhead ceiling or wall rails may be provided so that the mobile RFID portals can travel above, below or on the side of the space where the RFID-tagged assets are placed or found. As a mobile RFID portal travels along an overhead rail, it can read the RFID tags of assets that are present in the vicinity. Thus, the identity and/or the location of the assets that are present below may be determined by analyzing the read RFID tag information and the positions of the mobile RFID portals along the rails.

The system may include conventional mechanical and automated smart programming means for controlling or scheduling the movement of the mobile RFID portals on the overhead rails. The movement of the mobile RFID portals along the rails may be scheduled at convenient intervals to track the location of RFID-tagged assets continuously or at periodic intervals as desired. Further, the rail itself may provide the energy needed to power the RFID portal (reader).

### BRIEF DESCRIPTION OF THE DRAWINGS

Further features of the invention, its nature, and various advantages will be more apparent from the following detailed description and the accompanying drawings, wherein like reference characters represent like elements throughout, and in which:

FIG. 1 is a schematic block diagram of a mobile RFID portal, which includes RFID reader electronics and a radio for data communication with a wireless network, in accordance with the principles of the present invention;

FIG. 2 is a schematic representation of the mobile RFID portal of FIG. 1 configured as a motorized vehicle, which is deployed on a warehouse floor to read RFID tags on assets that are located on shelves along aisles in the warehouse, in accordance with the principles of the present invention;

FIG. 3a is a schematic illustration of a configuration of mobile RFID portals, which can travel on overhead rails, in accordance with the present invention.

FIGS. 3b and 3c are schematic representations of power supply arrangements for the mobile RFID portals utilized in the configuration of FIG. 3a, in accordance with the present invention.

FIG. 4 is a schematic representation of a configuration of RFID portals, which includes both stationary and mobile types of RFID portals. The mobile RFID portals include those that travel on overhead rails and those that that travel on the floor, in accordance with the present invention.

Throughout the figures, unless otherwise stated, the same reference numerals and characters are used to denote like features, elements, components, or portions of the illustrated embodiments.

### DETAILED DESCRIPTION OF THE INVENTION

In accordance with the invention, a configuration of mobile RFID portals is provided for use in the radio frequency identification and location of assets. The configuration of mobile RFID portals may be deployed in an area of interest to determine, on a continuous or periodic basis, the locations of RFID-tagged assets within the area.

For convenience in the description herein, a warehouse building (building 200 FIG. 2) is used as the exemplary area of interest. It will, however, be understood that the area of interest may be any area in which of assets are stored, moved or used (e.g. a transportation yard, retail store, a manufacturing plant, or other buildings or spaces). Warehouse building 200 may be serviced in a conventional manner by wireless and/or wired networks for data communications that, for example, are commonly used in present day business operations. FIG. 2 shows, for example, wireless access points 240 of a wireless data communications network 210, which is installed in building 200. FIG. 2 also shows, for example, Ethernet or cable switch 220 of a wired data communication network 240, which also may be installed in warehouse building 200 in addition to wireless data communications network 210.

Each mobile RFID portal in the configuration has at least one antenna/transceiver (“reader unit”) for reading RFID tags that are attached to assets. The reader unit may be any conventional low-power, low-cost unit. Similarly, the RFID tags may be low cost RFID tags (e.g., passive tags). The reader unit antenna may have an effective range “R” for reading RFID tags such that when stationary, the reader unit can effectively read RFID tags on assets that are located within a zone or area A (˜R2). The effective range R may be selected to be suitably short (e.g., about a few feet) to provide greater precision in the location of assets. Each mobile RFID portal also may be provided with a radio or other means by which it can communicate with a wireless or wired network that may be deployed for data communications in warehouse building 200.

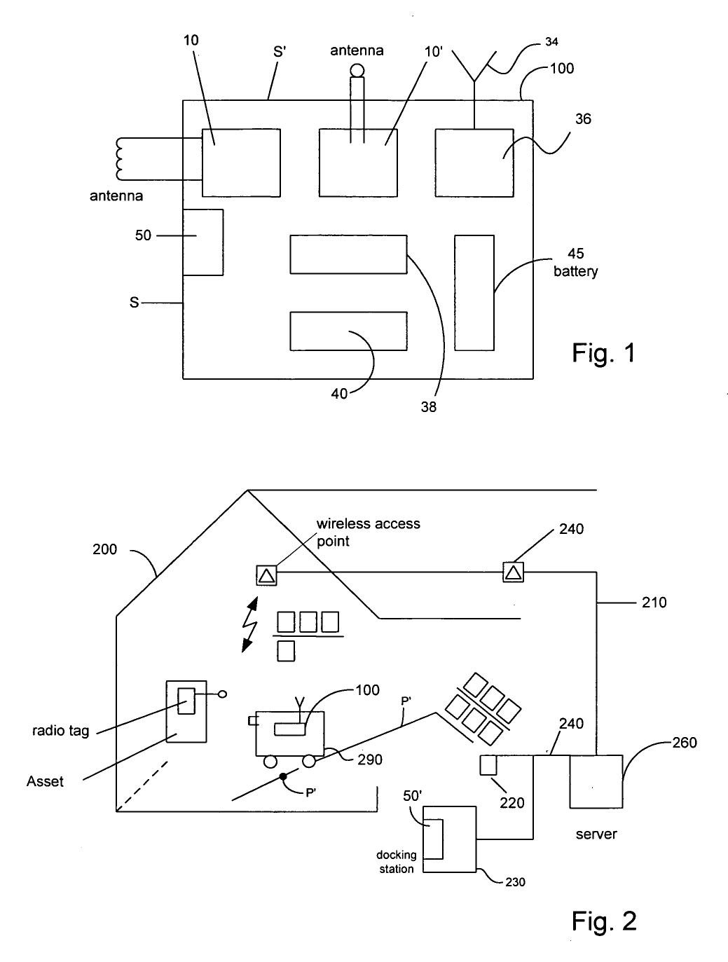

FIG. 1 shows a block diagram of an exemplary mobile RFID portal 100 that may be used in conjunction with the present invention to inventory RFID tagged assets in a warehouse building 200. Mobile RFID portal 100 includes one or more conventional antenna/transceiver reader units (e.g., reader units 10 and 10′). The reader units may have suitable orientations for reading RFID tags alongside, above or below mobile RFID portal 100. For example, the antennas of reader units 10 and 10′ may have specific orientations that respectively are suitable for reading RFID tags along sides S and S′ of the mobile RFID portal 100.

Reader units 10 and 10′ may be linked to a processor 38, which may be a microcontroller, microprocessor, digital signal processor, application-specific integrated circuit (ASIC) or any other control circuit, which may be known to one of ordinary skill in the art. Processor 38 also may communicate with an optional memory 40, which may be random access memory (RAM), read-only memory (ROM), or any other type of memory known to one of ordinary skill in the art. Processor 38 is additionally coupled to an optional one-way or two-way RF radio 36, which is equipped with an antenna 34 for sending and/or receiving data over a wireless network. RF radio 36 may configured for communicate with the particular type of wireless network 210 (e.g., an IEEE 802.11 or Bluetooth network or any other Wireless LAN or Wireless WAN) deployed in the warehouse. Depending upon the particular type of the wireless network, RF radio 36 may be a GPRS radio, 802.11b radio, Bluetooth radio, or any other device capable of transmitting and receiving data over the particular type of the wireless network. The circuits in RFID portal 100 may be powered by a battery (e.g., rechargeable battery 45).

Mobile RFID portal 100 may be disposed on a motorized robot or vehicle 290, which can be moved, for example, on the floor of warehouse building 200 in aisles between shelves on which RFID tagged assets are placed. Vehicle 290 may be a vehicle that is specifically designated for moving mobile RFID portal 100, or may be a vehicle which has other primary use in the warehouse operation (e.g., a forklift). The movement of vehicle 290 may be computer and/or remotely controlled using conventional control mechanisms (not shown). Mobile RFID portal 100/vehicle 290 may be provided with an optional docking interface 50 that can be coupled to a mating interface 50′, for example, at a vehicle docking station 230. Docking station 230 and interfaces 50/50′ may be conventionally configured to provide utilities to a docked RFID portal 100/vehicle 290. The utilities may, for example, include Ethernet connection (240) and/or power for recharging battery 45.

In operation, a mobile RFID portal 100/vehicle 290 may be moved along a planned path P (having a length L) through warehouse building 200. When mobile RFID portal 100 is at a position P′ on path P, the RFID reader units (i.e. reader unit 10 or 10′) can read RFID tags on assets that are within the range (i.e. within distance R from point P′). Accordingly, the locations of the assets whose RFID tags are read may be determined to be within a distance of about R from position P′. The position P′ of the mobile RFID portal 100 at a given instant in time may be monitored using conventional means (e.g., using mechanical or optical sensors or stops) or may be readily calculated from the kinetics (e.g., the speed and direction) of the mobile RFID portal 100.

Mobile RFID portal 100 may be moved at a suitable speed between different positions P′ along path P so that the reader units (e.g., reader units 10 and 10′) can properly read RFID tags on assets that located within a distance R of path P. Thus, a single movable RFID reader may be utilized to read RFID tags within an extended coverage area of equal to about the product of the length of the path and the range of the reader (i.e., an area of about L*R). Raw RFID tag data may be processed, for example, by RFID portal 100 to add a time stamp which indicates a time-of-read. Raw or processed RFID tag information collected at positions P′ may be communicated in real time to a database or server (e.g., database server 260) using optional radio 36 to communicate over wireless network 250. Alternatively or additionally, information read from the RFID tags by the reader units 10 and 10′ may be stored in memory 40 for later retrieval. Data stored in memory 40 may be retrieved at a convenient later time, for example, after RFID portal 100 has completed a run along path P. The stored data may be retrieved or downloaded in batches (e.g., run batches) and transmitted to data base server 260 via wireless network 250 using radio 36. In the version of mobile RFID portal 100 that is provided with optional docking interface 50, the stored data may be downloaded to database server 260 after mobile RFID portal 100 is docked at docking station 230. Any suitable wireless or wire connection between docking station 230 and server 260 (e.g., Ethernet connection 240) may be used to download the data.

An additional number N of mobile RFID portals 100 may be similarly moved along other paths P″ (not shown) so that all of the RFID tags in the area of interest can be read. The number N of RFID portals 100 utilized for this purpose may be suitably selected with due consideration to parameters such as the size of the area of interest, the number and range R of the RFID reader units, the degree of coverage overlap or redundancy desired, and other parameters, for example, the frequency at which asset inventory updates are desired. By deploying a suitable number N of mobile RFID portals 100 and moving them through the warehouse along convenient paths P at suitable speeds, information on the current assets in the warehouse or portions of the warehouse can be updated as frequently as every few seconds or only about every few hours as desired. The mobile RFID portals may be configured to record the time at which an RFID tag is read. Read RFID tag data may be time stamped with “time-of read” information using any suitable means (e.g., processor 38). By correlating the time-of-read stamps with the associated location of the assets, the system may be advantageously used to track or understand the movement of individual assets in the warehouse.

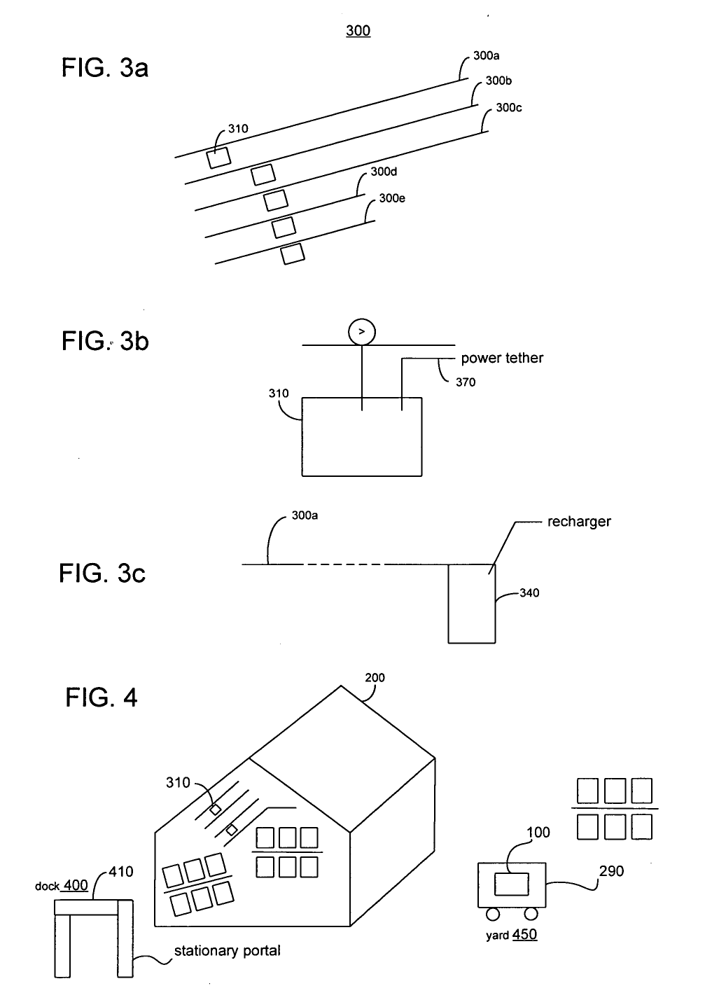

In another exemplary implementation of the invention, a number of mobile RFID portals may be advantageously deployed above the warehouse floor to avoid physical interference with other activities or personnel on the warehouse floor. In this implementation, an RFID portal vehicle (e.g., RFID portal trolley 310) may be configured to travel on or suspended from rails, guides or cables that extend above the areas in which the RFID-tagged assets are found. The rails, guides or cables may be mounted on or across the ceiling and/or walls of the warehouse building. FIG. 3a shows, for example, an exemplary pattern 300 of rails 300a-e, which is mounted from the ceiling of warehouse building 200 to provide RFID tag-reading capability or coverage over the entire area of interest. Rails 300a-e may have any conventional design or construction that is suitable for the guided movement of track vehicles (e.g., RFID portal trolleys 310). Further, RFID portal trolleys 310 may be configured to travel along rails 300a-e using conventional drive mechanisms (e.g., motors, wheels, cables and pulleys) (not shown). The drive mechanisms may be computerized or otherwise programmable so that RFID portal trolleys 310 may be moved along rails 300a-e according to a desired schedule for monitoring the location of and/or collecting information from the RFID-tagged assets in warehouse building 200.

In practice, exemplary RFID portal trolleys 310 may have box-like dimensions of about 8 inches×12 inches and enclose suitable reader electronics boards, processors, memory, and optional communication radio and/or docking interfaces. These components may be similar to corresponding components in RFID portal 100 (FIG. 1). For example, the reader electronic boards may be similar in function and design to reader units 10 or 10′ of RFID portal 100. It will be understood that the antennas of the reader electronics boards used in RFID portal trolleys 310 may suitably oriented to read RFID tags on assets placed underneath or below rails 300a-e.

RFID portal trolleys 310 may be powered by rechargeable batteries (e.g., FIG. 1 battery 45). Suitable trolley docking stations 340 may be provided at the ends of rails 300a-e for providing power for recharging the batteries. FIG. 3b shows an exemplary overhead docking station 340 at the end of a rail, which may be used to provide power and/or other utilities (e.g., Ethernet connections) to docked RFID portal trolleys 310. Alternative power supply arrangements may be used to power RFID portal trolleys 310 to avoid battery costs or for convenience. For example, rails 300a-e may be electrified to continuously supply power to moving RFID portal trolleys 310. In an alternate power arrangement, an extensible power tether 370 may provide power to a moving RFID portal trolley 310 (FIG. 3b).

The principles of the operation of the system of overhead RFID portal trolleys 310 for determining the location of assets inside warehouse building 200 may be similar, at least generally, to those involved in the operation of floor RFID portals 100/vehicles 290, which has been described herein with reference to FIGS. 1 and 2. Accordingly, for brevity and to avoid repetition, the operation of the system of overhead RFID portal trolleys 310 is not described herein in further detail.

It will be understood that the foregoing is only illustrative of the principles of the invention, and that various modifications can be made by those skilled in the art without departing from the scope and spirit of the invention. For example, a system of overhead RFID portal trolleys, and a system of floor RFID portal vehicles may be integrated with existing fixed or stationary portal systems (e.g., FIG. 4 stationary portal 410) to provide asset locations services over any desired area of interest (e.g., FIG. 4 building 200, dock 400, and yard 450). RFID tag information data collected by the various portals may be processed by a processor or server to track the location of RFID-tagged assets throughout the area or portions of the area.

1. A method for locating assets within an area, each asset having an RFID tag attached thereto, the method comprising:
providing at least one of mobile RFID portal having a range R for reading the RFID tags;
moving the mobile RFID portal along a path through the area to read RFID tags that are located within the range distance R from the path;
associating the location of the assets with points along the path according to RFID tag information read by the mobile tag reader.

2. The method of claim 1 wherein the mobile RFID portal comprises a wireless radio for communication with a wireless network, and wherein the method further comprises using the wireless radio to transmit RFID tag information over the wireless network.

3. The method of claim 1 wherein the mobile RFID portal comprises a memory for storing data, and wherein the method further comprises:
storing RFID tag information in the memory while the mobile RFID portal is in motion along the path; and
downloading the stored RFID tag information from the memory to a processor after the mobile RFID portal is stationary.

4. The method of claim 1 wherein moving the mobile RFID portal along a path through the area comprises moving the mobile RFID portal on the floor of the area.

5. The method of claim 1 wherein moving the mobile RFID portal along a path through the area comprises moving the mobile RFID portal above the RFID-tagged assets in the area.

6. The method of claim 5 further comprising providing a system of overhead rails in the area for moving the mobile RFID portal above the RFID-tagged assets in the area.

7. The method of claim 1 wherein providing at least one mobile RFID portal for reading RFID tags comprises providing a mobile RFID portal that operates on rechargeable batteries, and wherein the method further comprises providing docking stations in the area for recharging the rechargeable batteries.

8. The method of claim 1 wherein providing at least one mobile RFID portal for reading RFID tags comprises providing a mobile RFID portal having an interface for connection to a wired network for data communications; and wherein the method further comprises:
providing docking stations in the area with matching interfaces for connecting the mobile RFID portal to the wired network for data communications, and
periodically connecting the mobile RFID portal to the wired network for data communications.

9. The method of claim 1 wherein associating the location of the assets with the points along the path according to RFID tag information read by the mobile tag reader comprises:
determining the positions of the mobile RFID portal along the path; and
associating the RFID tags read by the mobile RFID portal at each position with the position.

10. The method of claim 1 further comprising adding a time stamp to the RFID tag information read by the mobile RFID portal for associating a time-of-read with the associated location of the assets.

11. The method of claim 1, further comprising:
providing a plurality of mobile RFID portals to read RFID tags along a multiple number of paths through the area.

12. A system for locating assets within an area, each asset having an RFID tag attached thereto, the system comprising:
at least one of mobile RFID portal having a range R for reading RFID tags;
means for moving the mobile RFID portal along a path through the area; and
a processor for processing RFID tag information read by the mobile RFID at different positions along the path to determine the location of the assets.

13. The system of claim 12 wherein the mobile RFID portal comprises a wireless radio for transmitting RFID tag information over a wireless network.

14. The system of claim 12 wherein the mobile RFID portal comprises a memory for storing RFID tag information while the mobile RFID portal is in motion along the path, the system further comprising means for downloading the stored RFID tag information from the memory after the mobile RFID portal is stationary.

15. The system of claim 12 wherein the mobile RFID portal is configured to move along the floor of the area.

16. The system of claim 12 wherein the mobile RFID portal is configured to move above the RFID-tagged assets in the area.

17. The system of claim 16 further comprising a grid of overhead rails in the area for moving the mobile RFID portal above the RFID-tagged assets in the area.

18. The system of claim 17 wherein the grid of overhead rails comprises an electrified rail for supplying power to the mobile RFID portal.

19. The system of claim 12 wherein the at least one mobile RFID portal for reading RFID tags comprises a mobile RFID portal that operates on rechargeable batteries, the system further comprising docking stations for recharging the rechargeable batteries.

20. The system of claim 12 wherein the at least one mobile RFID portal for reading RFID tags comprises an interface for connection to a wired network for data communications, and wherein the system further comprises docking stations having matching interfaces for connecting the mobile RFID portal to the wired network for data communications.

21. The system of claim 12, further comprising a plurality of mobile RFID portals to read RFID tags along a multiple number of paths through the area.
